(19) United States
(12) Patent Application Publication
(10) Pub. No.: US 2014/0118102 A1
(43) Pub. Date: May 1, 2014

(54) TELECOMMUNICATION SURGE PROTECTOR SYSTEM

(71) Applicant: SEAN IWASAKI, Chicago, IL (US)

(72) Inventor: SEAN IWASAKI, Chicago, IL (US)

(21) Appl. No.: 13/662,919

(22) Filed: Oct. 29, 2012

(51) Int. Cl. H01H 85/32; H01H 85/20

(52) U.S. Cl. CPC H01H 85/32; H01H 85/2015
USPC 337/187

(57) ABSTRACT

A telecommunication surge protector system is provided. The surge protector has a transparent housing having four peripheral pins and a single central pin. The four peripheral pins are electrically connected to surge/non-surge protection components and communication transmission lines. The surge protector further has a fusible link, a voltage limiting component and a current liming component. Damage to the fusible link is visible through the transparent housing. The transparent nature of the housing also provides visual indication of the status of the communication transmission service with respect to the non-surge protection components. The present five pin surge protector is inserted into a socket of the telecommunication system. The socket of the present system has five openings, all of which are shallow; therein preventing the accidental insertion of a non-fusing surge protector pin into the system.

### CROSS REFERENCE TO RELATED APPLICATIONS

The present application is based on U.S. provisional application No. 61/553,310 filed on Oct. 31, 2011, currently co-pending, the entire contents of which are incorporated by reference. Applicant claims the priority benefit of the 61/553,310 application.

### BACKGROUND OF THE INVENTION

A telecommunication surge protector system is provided. The surge protector has a transparent housing having four peripheral pins and a single central pin. The four peripheral pins are electrically connected to surge/non-surge protection components and communication transmission lines. The surge protector further has a fusible link, a voltage limiting component and a current liming component. Damage to the fusible link is visible through the transparent housing. The transparent nature of the housing also provides visual indication of the status of the communication transmission service with respect to the non-surge protection components. The present five pin surge protector is inserted into a socket of the telecommunication system. The socket of the present system has five openings, all of which are shallow; therein preventing the accidental insertion of a non-fusing surge protector pin into the system.

Every year numerous people are injured and valuable property is destroyed as a result of electrical damage from a surge in voltage and currents from telecommunication networks. The financial costs of these damages are expensive in terms of both medical treatment as well as repairs needed to fix the telecommunications system. As a result, surge protectors are often implemented in telecommunication systems.

As customers demand higher speed communication, communication service providers responded by deploying cabinets or enclosures containing highly integrated electronic communication equipment throughout their outside plant facility. These cabinets provide a customer service demarcation, which is an RJ type jack or other types of communication connectors such as coax connectors, IDC punch-down blocks, and wire terminal blocks. Because this customer service demarcation connector is exposed to the outdoor environment, the communication service provider will install a primary surge protection device behind the customer service demarcation connector to protect the cabinet's communication electronic equipment and personnel.

In this outdoor cabinet application, proper surge protection design involves the installation of a fusible link between the service connector and the surge protection device. A fusible link is designed to act as a safe and identifiable weak link in an overall primary surge protection solution. When a primary surge protection solution encounters an extreme surge, the fusible link will fail “open” and prevent the extreme surge from further damaging the outdoor cabinet and equipment and preventing injury. If a fusible link is not used, the primary surge protector may not limit and contain the extreme surge from uncontrolled damage. The primary surge protector can only shunt a certain amount of surge energy. A fusible link is a 6″-12″ length cable that is 2 gauges smaller than the wire pair used to deliver the communication service. A typical installation of a fusible link involves two 66 Type Punchdown Blocks, which are used to install a fusible link between the exposed cable and the five pin surge protectors. Due to customer service applications and installation variations the physical space, cost, and time required to install a fusible link is often not performed.

Furthermore, the use of a RJ type connector as a service demarcation complicates the definition and implementation of the fusible link. A fusible link is defined with respect to the connecting cable, not a RJ type connector or other service connector types. Due to the RJ type connector design, the fusible link should be defined with respect to the connector.

It is common to use five pin surge protectors in an attempt to limit unwanted surge voltages and currents from damaging equipment and facilities within the telecommunication network. These unwanted electrical surges may arise from the effects of, for example, lightning and/or power-line faults. During use, the five pin surge protector is typically installed in a socket which connects to an unprotected transmission cabling. The five pin telecommunication surge protector provides surge protection by voltage limiting or voltage and current limiting. When triggered by an excessive voltage, the five pin telecommunications surge protector may be damaged and may need to be replaced.

A telecommunication surge protector is the “primary” or first device used to limit unwanted electrical surges entering a system from the outside environment. As an industry standard, most telecommunication surge protectors have five pins. More specifically, these traditional telecommunication surge protectors have a central pin, two shorter identical peripheral pins of equal length and two longer identical peripheral pins of equal length all secured within a colored housing unit. The shorter pins are often used in testing and troubleshooting as a result of disruptions in telecommunication systems. More specifically, in a traditional environment, the shorter identical peripheral pins may be removed and tested while the longer identical peripheral pins remain connected in the socket. These telecommunication surge protectors are typically either voltage-limiting or voltage-current limiting surge protector devices, wherein surges are shunted to ground.

In order to determine if the traditional surge protector is damaged, a technician may be required to remove the five pin surge protector from the socket assembly for testing of the surge protector. The technician is therein required to carry or have access to the testing equipment. Further, when testing, the telecommunications service is temporarily disrupted.

The traditional five pin surge protector generally has a metallic test point wherein the technician can measure the continuity of the internal five pin surge protector mechanism. A failure is indicated with the measurement of a “short” or very low resistance. This failure indicates the voltage-limiting device is likely damaged and needs to be replaced. A pass is indicated with a measurement of an “open” or high resistance; although such traditional tests are not always reliable. Further, these traditional tests require the technician to carry and use portable test equipment for testing the same. Attempts have been made to provide a surge protector which is used in telecommunications with can limit this damage. More specifically, U.S. Pat. No. 6,731,489 to Heidorn et al. discloses a Category 5 (as well as newer revisions, such as Category 6 and Category E)/single-pair surge protector module for protecting telecommunications related equipment and the like from transient voltage and current surges includes a two-piece interfitting housing which receives a miniature printed circuit board therein. The miniature printed circuit board is used to mount a Category 5 (as well as newer revisions, such as Category 6 and Category E)/circuit surge protector device. The surge protector device includes a pair of voltage suppressors and four banks of diodes.

Further, U.S. Pat. No. 6,084,761 to Casey et al. discloses a telephone line protection module having a printed circuit board socket with conductive paths connected to pins of the module. Overvoltage sensitive semiconductor devices are soldered to the ends of a conductive bridge, and the bridge is spring-biased between a module cover and the conductive bridge. The semiconductor devices are thus forced into electrical contact with the printed circuit paths. In addition, in the event the semiconductor devices are thermally destroyed, the conductive bridge is forced by the spring into direct contact with the printed circuit paths.

U.S. Pat. No. 5,034,846 to Hodge et al. discloses a terminal connector or plug protector is selectively configurable for coupling or coupling and protecting an electronic communication circuit to a communication line. The plug protector has a housing and a circuit board which is received in the housing. The circuit board has thereon a circuit which includes a plurality of circuit elements removably received in the circuit board. The circuit is coupled to the communication circuit and to the communication line with the circuit elements coupled there between. The circuit elements are selected from among a plurality of circuit element types, i.e., jumper wires, solid state voltage suppressors, and fusible links, to configure the plug protector for the selected coupling or coupling and protecting.

U.S. Pat. No. 5,031,067 to Kidd et al. discloses a five pin protector module for telephone circuits comprises two input pins, two output pins and a grounding pin, all on an insulative socket. The electrical current path between each input pin and its respective output pin comprises an electrically conductive arm, a current responsive assembly and an electrically conductive helical spring. The module contains a bidirectional voltage sensitive switch which prevents input voltage surges from reaching the output but, instead, conducts them to a grounding member to which the grounding pin is attached.

Further, attempts have been made to provide a surge protector with indicating means. More specifically, U.S. Pat. No. 3,587,021 to Baumbach et al. discloses a line protector which provides indicating means by protruding printed board extension through openings in the top of the housing during sustained overcurrent conditions. During a sustained overcurrent condition a fusible pellet melts and releases the spring mechanism which pushes upward the printed board extension through openings in the top of the housing.

U.S. Pat. No. 4,091,435 to Ahuja et al. discloses a telephone protector module having heat coil fired flag indicator. The indicating means involve the melting of a “thin film” which will release a spring type mechanism to push a plunder through an opening in the top of the housing.

U.S. Pat. No. 4,876,626 to Kaczmarek et al. discloses a central office protector module with alarm indicator means. The ‘626’ patent overcomes the limitation of the ‘021’ patent by using a sealed housing with a protrusion for a light indicator. During overcurrent conditions, a solder pellet melts and actuates a contact closure between the protector module ground and alarm external pins to illuminate the light indicator. However, the indicating means of patents ‘021’, ‘435’, and ‘626’ using the melting of material to release a spring type mechanism under sustained overcurrent conditions is not reliable. The material can vary in size and shape uniformity which will alter the melting behaviour and result in false indication. Openings in the top of the housing will allow environmental conditions such as humidity and dust particles to contaminate the line protector assembly and indicating mechanism. This contamination will compromise the reliability of the surge protection functionality and indicator mechanism. The ‘626’ patent uses six pins which requires a non-standard or proprietary protector socket assembly. The ‘626’ patent also requires an external equipment to supply power to the protector module alarm pin for light illumination.

However, these telecommunication surge protectors fail to disclose a telecommunication surge protector which is easy to use and safe in the manner provided herein. A need, therefore, exists for an improved telecommunications surge protector and method of using the same.

### SUMMARY OF THE INVENTION

A telecommunication surge protector system is provided. The surge protector has a transparent housing having four peripheral pins and a single central pin. The four peripheral pins are electrically connected to surge/non-surge protection components and communication transmission lines. The surge protector further has a fusible link, a voltage limiting component and a current liming component. Damage to the fusible link is visible through the transparent housing. The transparent nature of the housing also provides visual indication of the status of the communication transmission service with respect to the non-surge protection components. The present five pin surge protector is inserted into a socket of the telecommunication system. The socket of the present system has five openings, all of which are shallow; therein preventing the accidental insertion of a non-fusing surge protector pin into the system.

By the present invention, a fusible link is provided for use in connection with a telecommunication surge protector. When the telecommunication surge protector is damaged due to an unexpected heightened electrical surge, the fusible link will fail and create black smoke, emit particles, and show visible damage through a clear housing. The clear housing will allow the technician to quickly and accurately determine any damage to the telecommunication surge protector without the need to remove the pins from the socket.

Non-surge protection components can be incorporated into the telecommunication surge protector to provide visual indication on the status of the telecommunication surge protector and the connected communication transmission service. The clear housing of the present device will allow the technician to visually identify the non-surge protection component's status indicators without the need to remove the surge protector from the system. As a result, the technician may quickly and accurately perform maintenance and repair of the communication transmission service. Further, the present five pin telecommunication surge protector has fusing, voltage-limiting circuitry, current limiting circuitry, and non-surge protection components located within the transparent housing. Fusing changes the functionally of the five pin protectors from surge shunting to opening (i.e. fusible link opens). The telecommunication surge protector of the present device allows a user to easily and quickly differentiate a working five pin surge protector from a non-working five pin surge protector.

Two types of five pin surge protectors may be used; a non-fusing five pin surge protector or a fusing five pin surge protector. A five pin surge protector which supports fusing is termed a fusing five pin surge protector. The fusing five pin surge protectors support a voltage-limiting or a voltage-current limiting mechanism. The fusible link of the present five pin surge protector allows the telecommunication surge protector to be used without installing a fusible link and may allow the present five pin surge protector be installed as a primary surge protector directly connect to the outdoor exposed interface. The present five pin surge protector may also be installed in an agnostic socket directly to a specific service connector and cabling.

Most telecommunication surge protectors used contain five pins wherein the five pins are inserted into five separate sockets. The surge protector works by limiting the voltage and current passing through the electrical network. A typical non-fusing (also called a ‘shunting’) five pin surge protector has two long and two short pins surrounding a centrally located pin. A typical fusing five pin surge protector has four short pins surrounding a centrally located pin. To ensure against unintentional or accidental installation of non-fusing five pin surge protectors into a telecommunication system requiring a fusing five pin telecommunication surge protector, the socket component of the present system only accepts four short pins of the surge protector. More specifically, the present five pin surge protector socket (or ‘connector socket’) of the present system is designed to only accept four short pins thereby preventing the installation of a non-fusing five pin surge protector. Even further, the five pin surge protector of the present device has four short pins which provide another visual indication that this device is a fusing or fused five pin telecommunication surge protector.

An advantage of the pin telecommunication surge protector of the present system is that a user may quickly check to see if the five pin telecommunication surge protector has been triggered without the need to remove the five pin housing from the socket.

Yet another advantage of the present pin telecommunication surge protector is that the telecommunication surge protector saves time.

And an advantage of the five pin telecommunication surge protector of the present invention is that the present device allows a user to easily and quickly differentiate a working five pin surge protector from a non-working five pin surge protector.

A still further advantage of the present five pin telecommunication surge protector is that the present device allows a user to eliminate unintentional or accidental installation of a non-fused five pin surge protector into an application requiring a fusing five pin telecommunication surge protector having four short openings for receiving the four short identical pins.

And another advantage of the present five pin telecommunication surge protector is that the present device lacks any openings and is therefore suitable for use outdoors in poor weather conditions.

Yet another advantage of the present five pin telecommunication protector is that the present device has an interior LED light which allows a user to determine if the device or connected communication service is functional without the need to remove the housing and test the device.

Yet another advantage of the present system is that the present system does not require a technician to carry heavy testing equipment to test of a surge protector is still functional.

For a more complete understanding of the above listed features and advantages of the present five pin telecommunication surge protector, reference should be made to the following detailed description of the preferred embodiments. Further, additional features and advantages of the invention are described in, and will be apparent from, the detailed description of the preferred embodiments.

### BRIEF DESCRIPTION OF THE DRAWINGS

FIG. 1 illustrates a front perspective view of the five pin telecommunication surge protector (and prior art surge protector) wherein the housing of the surge protector is secured to the socket.

FIG. 2 illustrates a front perspective view of the five pin telecommunications surge protector having a transparent housing being inserted into the socket.

FIG. 3 illustrates a detailed view of the clear transparent housing of the device wherein the housing is being inserted over the internal components of the surge protector.

FIG. 4 illustrates a front view of the five pin electrical surge protector.

FIG. 5 illustrates a bottom view of the five pin electrical surge protector.

FIG. 6 illustrates a side view of the five pin electrical surge protector.

FIG. 7 illustrates top view of the five pin electrical surge protector.

FIG. 8 illustrates a front perspective view of the transparent surge protector when an internal fusible link is blown.

### DETAILED DESCRIPTION OF THE PREFERRED EMBODIMENTS

A telecommunication surge protector system is provided. The surge protector has a transparent housing having four peripheral pins and a single central pin. The four peripheral pins are electrically connected to surge/non-surge protection components and communication transmission lines. The surge protector further has a fusible link, a voltage limiting component and a current liming component. Damage to the fusible link is visible through the transparent housing. The transparent nature of the housing also provides visual indication of the status of the communication transmission service with respect to the non-surge protection components. The present five pin surge protector is inserted into a socket of the telecommunication system. The socket of the present system has five openings, all of which are shallow; therein preventing the accidental insertion of a non-fusing surge protector pin into the system.

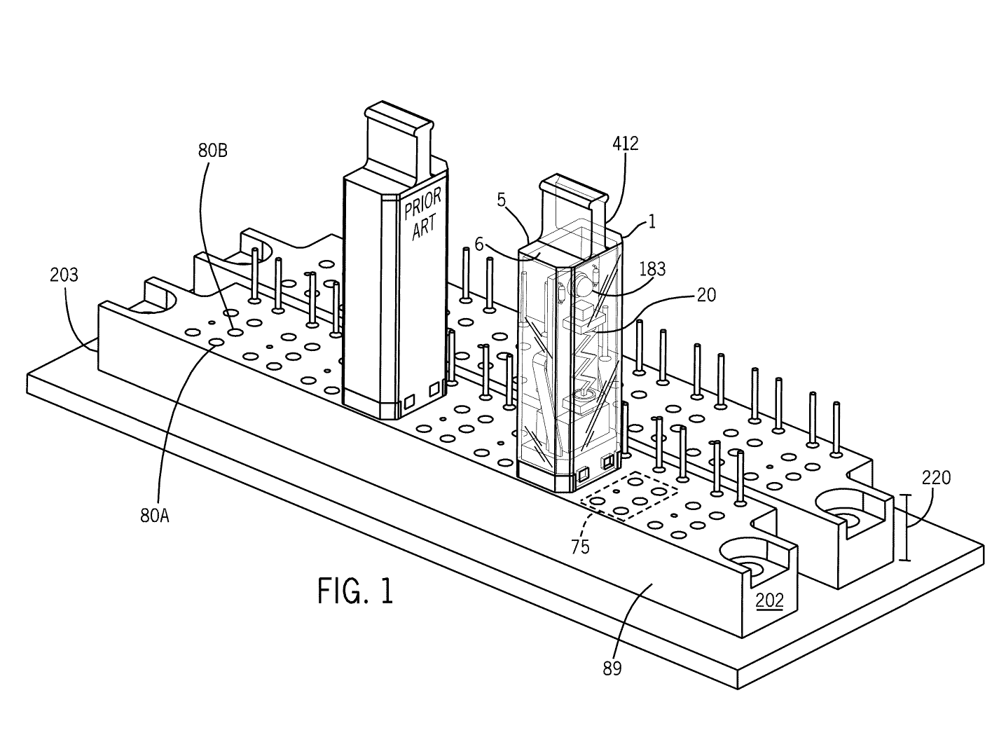

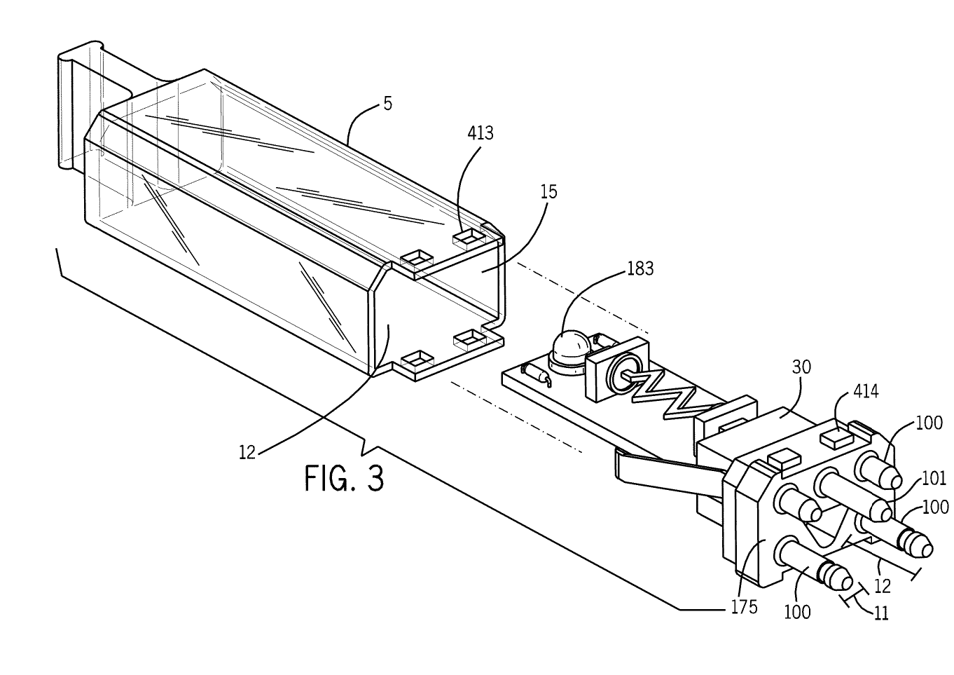

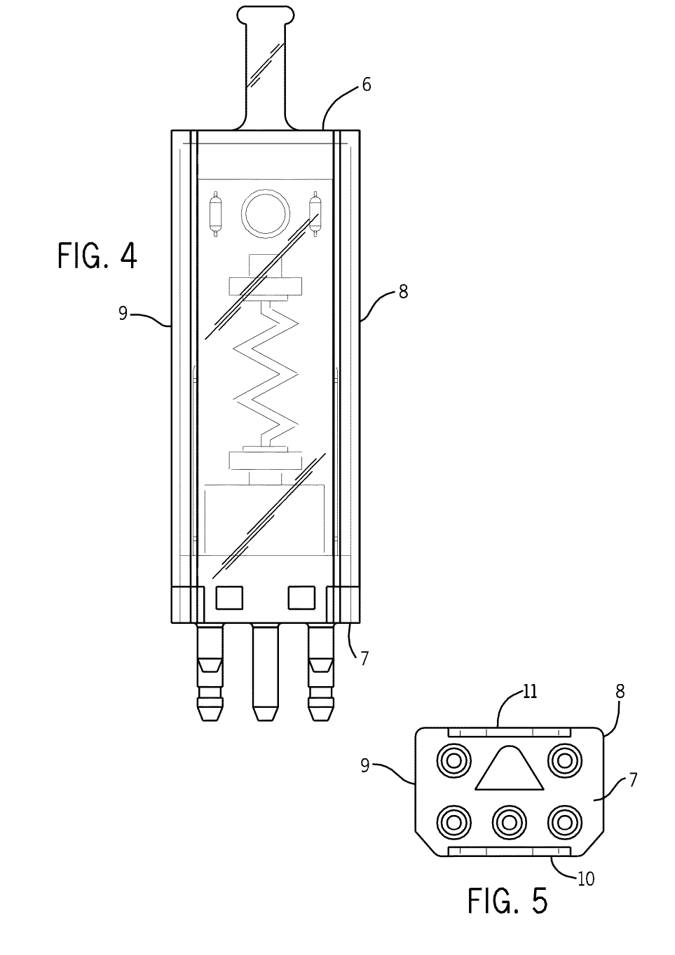

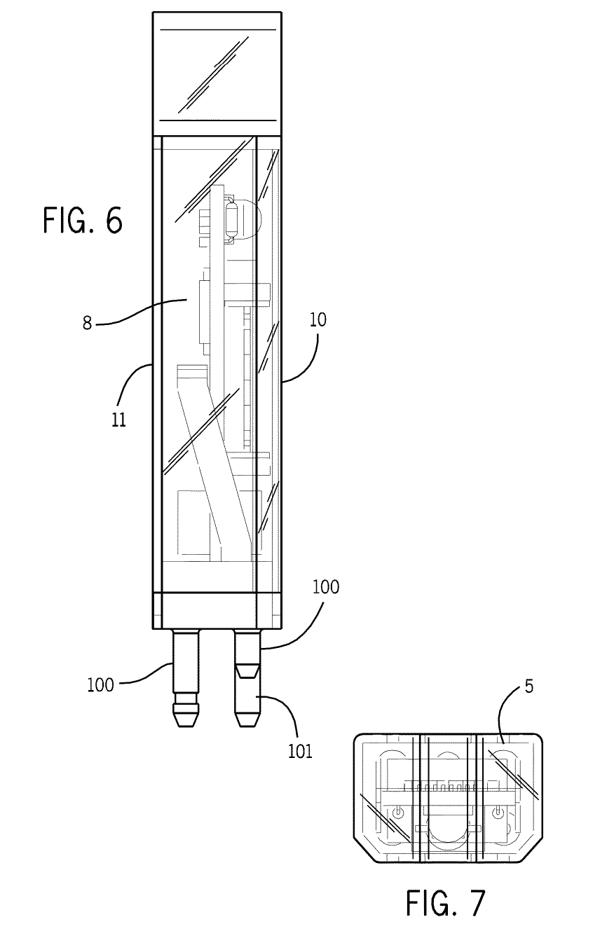

Referring now to FIG. 1, a telecommunication surge protector 1 is provided. A prior art non-transparent surge protector is also illustrated in FIG. 1 connected to a receiving strip. The telecommunications surge protector 1 of the present application may have a housing 5 and a plurality of peripheral pins 100 (FIG. 3). With respect to the current device 1, there are four main peripheral pins 100 and one central pin 101; however, alternative embodiments may have an alternative number of peripheral pins 100. In an embodiment, the one central pin 101 may be located substantially between two of the four of the plurality of main peripheral pins 100.

The housing 5 of the present device 1 may be generally rectangular and preferably made from plastic. More specifically, the housing 5 may have a top 6, a bottom 7, a first side 8, a second side 9, a front 10, a back 11 and a generally hollow interior 12 (FIG. 3). The bottom 7 of the housing 5 may have an opening 15 wherein electrical components may extend outward, away from the interior 12 of the housing 5. Further, the housing 5 of the telecommunications surge protector 1 is transparent such that a user may view the interior 12 electrical components therein.

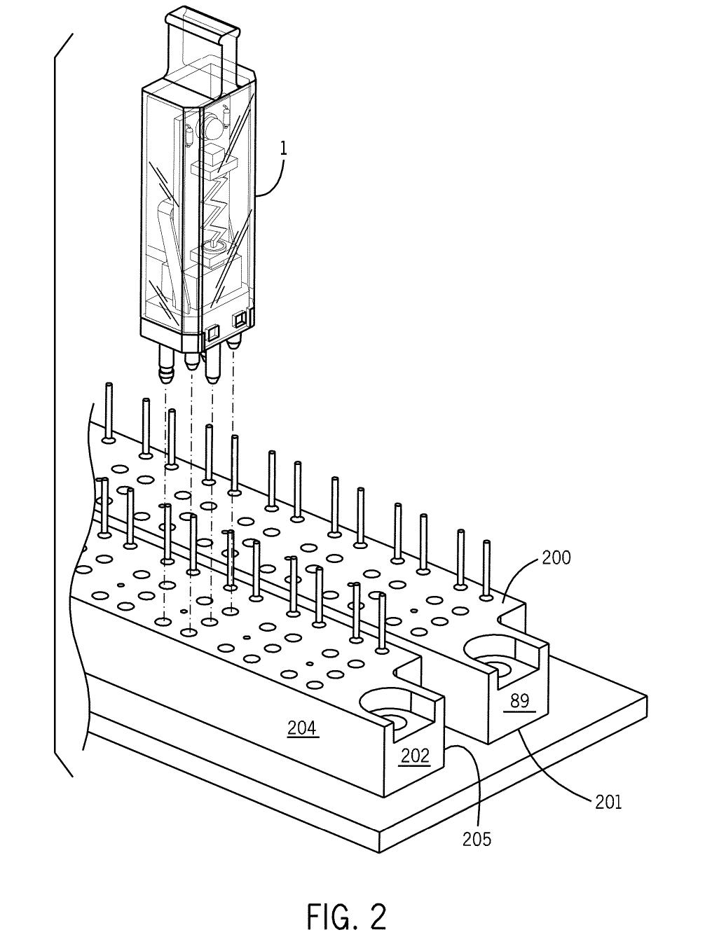

Referring now to FIG. 2, within the interior 12 of the housing 5 may be the electrical components of the telecommunication surge protector 1. More specifically, a voltage limiting device 20 may be present. The voltage limiting device 20 may be triggered if there is a predetermined surge in electrical current which would damage the telecommunications system. Electrically attached to the voltage limiting device 20 may be the plurality of peripheral pins 100 which plug into a socket 75 of a telecommunications system.

The plurality of peripheral pins 100 may be generally cylindrical in nature. Further, the plurality of peripheral pins 100 may be made from an electrically conductive metal and may transfer an electrical charge. Two of the plurality of peripheral pins 100 may have a diameter 11 (FIG. 3) and a length 12. The plurality of peripheral pins 100 of the present device 1 may be of varying lengths or may all be substantially identical to one another. In the drawings, two of the plurality of peripheral pins 100 are long and two are short.

The plurality of peripheral pins 100 may extend outward, from the bottom 7 of the housing 5. The plurality of peripheral pins 100 may run substantially parallel with respect to one another. The plurality of peripheral pins 100 may be inserted into the socket 75 of the telecommunications system wherein each socket 75 has a plurality of openings 80A (FIG. 1) equal to the number of the plurality of peripheral pins 100 of the housing 5. A second opening 80B, also part of the socket 75, may be located in the middle of two of the plurality of openings 80A and may be used to temporarily secure the one central pin 101 of the device 1. The receiving strip 89 may have a plurality of sockets 75 such that a plurality of telecommunication surge protectors 1 may be inserted into a single receiving strip 89.

The plurality of openings 80A of the socket 75 of the present receiving strip 89 may have a diameter 81 and a length 82. The diameter 81 of the openings 80A may be slightly greater than the diameter 11 of the plurality of peripheral pins 100 such that the plurality of peripheral pins 100 snugly fits within the plurality of openings 80A of the socket 75 during use of the telecommunications surge protector 1. Further, the plurality of peripheral pins 100 may be secured into the openings 80A of the socket 75 during use by, for example, friction.

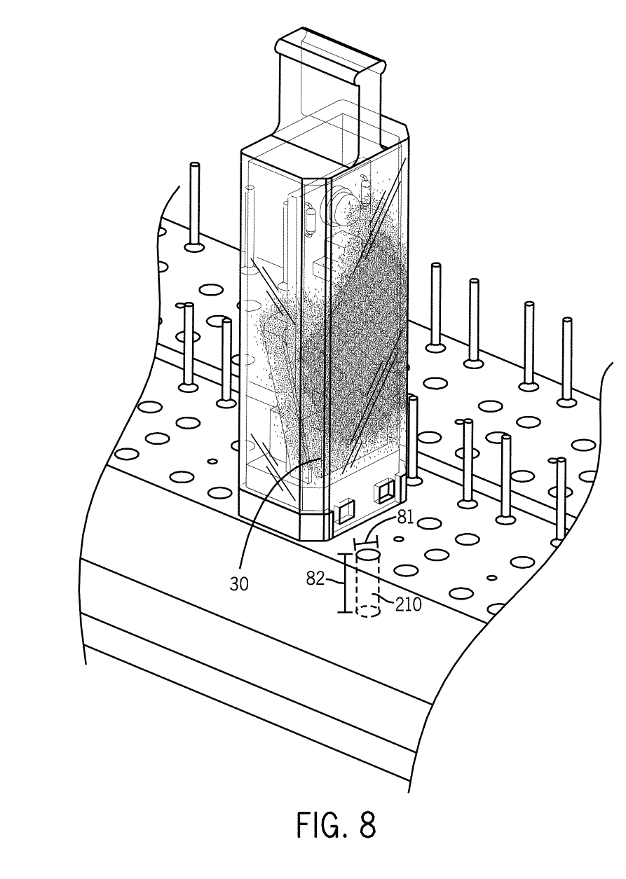

The length 82 (FIG. 8) of the openings 80A of the present receiving strip 89 are less than the length of at least the long pins of a traditional surge protector such that the entire length of the long pins of a traditional surge protector cannot be fully inserted into the more shallow openings 80A of the present receiving strip 89. As a result of at least a portion of the short pins and at least a portion of the long pins of a traditional not being fully secured in the openings of the socket, the traditional surge protector cannot be fully and securely secured in the receiving strip 89 of the present system. As such, electrical communication between a traditional surge protector and the receiving strip 89 of the present system is either not possible or diminished so to make traditional surge protectors not properly functional. Because the length 82 of the openings 80A of the present sockets 75 are less than at least some of the lengths of the pins of a traditional surge protector, a user cannot improperly install a non-fusing surge protector into the sockets 75 of the present system.

A fusible link 30 (FIG. 3) may be located within the housing 5 of the telecommunications surge protector 1. The fusible link 30 may be activated (or triggered) when a predetermined electrical current capacity of the attached cabling or connector (not shown) is exceeded. If the current capacity is exceeded, the fusible link 30 burns out and the clear housing 5 may become darkened with smoke (FIG. 8) and/or burn marks from the damage to the fusible link 30. As a result, a user can easily see if the fusible link 30 of the telecommunications surge protector 1 has been triggered through the transparent housing 5 without the need to remove the device 1 from the socket 75 to test.

As stated above, the surge protector 1 may plug into sockets 75 of a receiving strip 89. The receiving strip 89 may have a top 200, a bottom 201, a front 202, a back 203, a first side 204, a second side 205 and an interior 210. The front 202 and the back 203 of the receiving strip 89 may have a height 220. The drawings illustrate the receiving strip 89 as rectangular in shape; however the receiving strip 89 may be of any suitable shape. As stated above, the socket 75 of the receiving strip 89 of the telecommunication system may have a plurality of openings 80A. Generally, the sockets 75 are located on the top 200 of the receiving strip 89. The openings 80A of the sockets 75 may be generally cylindrical and may extend from the top 200 of the receiving strip 89 downward toward the bottom 201 of the receiving strip 89, through the interior 210. The openings 80A may each have a length 82 which is less than the height 220 of the front 202 and back 203 of the receiving strip 89.

The length 82 of the openings 80A of the sockets 75 of the receiving strip 89 may all be identical to each other and may further may be substantially identical to the length 12 of the plurality of peripheral pins 100. As a result of the lengths 82 of the openings 80A being identical to each other and also identical in length to the length 12 of the pins 100; if a user removes the plurality of peripheral pins 100 of the device 1 from the openings 80A of the socket 75 all four of the plurality of peripheral pins 100 (and the central pin 101) will lose electrical contact with the socket 75 of the receiving strip 89. Further, if a user attempts to improperly secure a traditional surge protector (ie: one having two long and two short pins) into the openings 80A of the socket 75 of the present receiving strip 89, the user will be prevented from the surge protector 1 locking into place as a result of the two long pins of a traditional surge protector not being able to be fully inserted into the shortened length 82 of the present openings 80A of the socket 75 of the receiving strip 89. Therefore, only the plurality of peripheral pins 100 and housing 5 of the present invention may be used in conjunction with the socket 75 of the present device 1.

The plurality of peripheral pins 100 and the central pin 101 may extend through a generally rectangular covering 175 (FIG. 3) located on the bottom 7 of the housing 5. The generally rectangular covering 175 may act as a base which supports the pins 100, 101 and other electronic components of the device 1. The generally rectangular covering 175 may have a securing mechanism which allows the housing 5 of the device 1 to be snapped onto the generally rectangular covering 175 and remain temporarily secured to the generally rectangular covering 175. To service the system, an installer may remove the housing 5 to access the electronic components of the system or the installer may remove the entire housing 5, generally rectangular covering 175 and electronic components together. The generally rectangular covering 175 may substantially cover the bottom 7 of the housing 5 such that a liquid tight seal is created between the generally rectangular covering 175 and the housing 5. As a result, the device 1 may be used outside in poor weather conditions. Referring now to FIG. 8, if the fusible link 30 located within the generally hollow interior 12 of the housing 5 of the surge protector 1 is blown, the smoke created from the blown fusible link 30 will cover a portion of the interior of the transparent housing 5 therein allowing an installer to determine the inoperable status of the device 1 without the need to remove the housing 5 of the device 1 as is required in other surge protectors.

Finally, within the interior 12 of the housing 5 may be a visible indicator 183. In this embodiment the visible indicator is an LED light. The LED light 183 may be electrically connected to at least one of the plurality of pins 100. The LED light 183 may indicate that the device 1 or connected communication service is operational and functional. As a result, a user may see if the LED light 183 is on and the device 1 is functional through the transparent housing 5 without the need to remove the housing 5 from the generally rectangular covering 175 and without the need to test the surge protector 1.

The top 6 of the housing 5 may have a grasping mechanism 412 which may allow for the easy insertion or removal of the device 1 from the socket 75. Near the bottom 7 of the housing 5 may be a plurality of openings 413. The plurality of openings 413 may be, for example, generally rectangular. The plurality of openings 413 may be placed over and may be secured by tabs 414 located on the rectangular covering 175 of the device by, for example, friction. More specifically, the tabs 414 may secure the housing 5 to the rectangular covering 175 and all the electronic components therein connected to the rectangular covering 175.

Referring now to FIG. 8, when the fusible link 30 in the interior 12 of the surge protector 1 is blown, the fusible link 30 creates a dark smoke that at least partially covers the transparent housing 5 allowing the user to determine by sight (without removing the surge protector 1 from the socket 75) if the fusible link 30 is blown.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

1. A surge protector comprising;
a housing having a top, an open bottom, a front, a back, a first side, a second side and a generally hollow interior;
a fuse component located within the interior of the housing;
a plurality of pins located within the interior of the housing and extending beyond the open bottom of the housing wherein the plurality of pins are electrically connected to the fuse component;
a protective covering substantially covering the open bottom of the of the housing wherein the protective covering mechanically is secured to the plurality of pins and the fuse component; and
wherein the housing is transparent.

2. The surge protector of claim 1 wherein the surge protector has a fusible link.

3. The surge protector of claim 1 wherein the plurality of pins are all of substantially identical length.

4. The surge protector of claim 1 wherein the plurality of pins are of at least two different lengths.

5. The surge protector of claim 1 further comprising:
a grasping mechanism located on the top of the housing wherein the grasping mechanism allows a user to easily insert or remove the surge protector from a socket.

6. The surge protector of claim 1 further comprising:
a plurality of opening located near the bottom of the housing wherein the plurality of openings are temporarily secured around substantially identically sized tabs located on the protective covering of the housing.

7. The surge protector of claim 1 wherein the housing may be removed from the protective covering, the pins and the fusible link.

8. The surge protector of claim 1 further comprising:
a visible indicator located within the interior of the housing wherein the visible indicator allows a user to determine if the surge protector is operational without the need to remove the housing.

9. The surge protector of claim 8 wherein the visible indicator is an LED light.
